(19) United States
(12) Patent Application Publication
(10) Pub. No.: US 2009/0100338 A1
(43) Pub. Date: Apr. 16, 2009

(54) INTERACTIVE MULTIMEDIA SYSTEM

(75) Inventor: Ricardo Saetti, Cognento (IT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: LINK FORMAZIONE S.R.L., Cognento (IT)

(21) Appl. No.: 12/282,455

(22) PCT Filed: Mar. 5, 2007
(86) PCT No.: PCT/IT2007/000160

§ 371 Date: Sep. 29, 2008

(30) Foreign Application Priority Data
Mar. 10, 2006 (IT) RM2006 A 000136

(51) Int. Cl. G06F 3/03; G06F 3/01; G06F 17/00; H04N 7/18; G10L 21/00

(52) U.S. Cl. 715/716; 340/825.25; 704/275; 348/61; 340/573.1

(57) ABSTRACT

The present invention concerns an interactive multimedia system comprising processing electronic means that controls multimedia playing means for playing at least one video and/or audio content, wherein it further comprises detecting means, capable to detect presence of at least one participant within an interaction area (A) having a floor treadable by said at least one participant, connected to the processing electronic means, said at least one video and/or audio content played on the multimedia playing means being conditional on at least one signal received by the processing electronic means from the detecting means.

The present invention concerns an interactive multimedia system, preferably installable in areas of commercial structures (such as for instance shops, supermarkets, shopping centres, exhibition stands) or public structures (such as for instance halls of stations, ports, airports, museums), that allows delivery to one or more persons, passing through the area, of communications, information or entertainment opportunities, according to a quick and immediate interaction with the persons, customising messages, times and reactions on the basis of different detected data, in particular on the numerousness and types of the persons, so as to react in an immediate and appropriate way to different events (such as for instance entries, exits, movements of persons, physical movements and posture changes, selections made by the persons). In particular, the system, by stimulating the attention of the persons to whom it addresses and ensuring their strong participation, is extremely efficient, reliable, and simple to use.

It is known that; apparatuses and systems are presently increasingly diffusing in commercial structures and in public structures which allow delivery of communications, information or entertainment opportunities to people who pass.

By way of example, in commercial structures, such as for instance shops, supermarkets, shopping centres, or exhibition stands, such apparatuses may comprise screens and loudspeakers playing video and audio messages, most of all for advertising and information purposes.

Similarly, in public structures, such as for instance stations, ports, airports, museums, such apparatuses may comprise screens and loudspeakers, or even portable audio players, delivering communications and information to passengers and visitors, and/or allowing projection of films for entertaining passengers and visitors while waiting.

However, such apparatuses and systems suffer from the drawback that interactivity allowed to participants is rather low, and typically it is limited to make selections of communications and information through keys.

This entails that delivered communications are not sufficiently pleasant for participants, causing a poor attention and receipt of communication and information contents.

It is therefore an object of the present invention to allow, in a reliable, simple, and inexpensive way, delivery to one or more persons of communications, information or entertainment opportunities, according to a quick and immediate interaction with the persons, customising messages, times and reactions on the basis of behaviours of the same persons.

It is specific subject matter of the present invention an interactive multimedia system comprising processing electronic means that controls multimedia playing means for playing at least one video and/or audio content, characterised in that it further comprises detecting means, capable to detect presence of at least one participant within an interaction area having a floor treadable by said at least one participant, connected to the processing electronic means, said at least one video and/or audio content played on the multimedia playing means being conditional on at least one signal received by the processing electronic means from the detecting means.

Always according to the invention, the detecting means may comprise photoelectric means capable to generate one or more light beams and to detect interruption of said one or more light beams when they are intersected by an outline of said at least one participant.

Still according to the invention, the photoelectric means may comprise one or more photoelectric sensors or photoelectric cells which receive said one or more light beams generated by one or more corresponding light emitters.

Furthermore according to the invention, said one or more photoelectric sensors or photoelectric cells may face said one or more corresponding light emitters.

Always according to the invention, at least one portion of said one or more light beams may be generated according to at least one direction parallel to the floor of the interaction area.

Still according to the invention, at least one portion of said one or more light beams may be generated according to at least one direction orthogonal to the floor of the interaction area.

Furthermore according to the invention, the floor of the interaction area may be capable to reflect said one or more light beams and said one or more photoelectric sensors or photoelectric cells and said one or more corresponding light emitters may be arranged in the same floor or in a ceiling of the interaction area.

Always according to the invention, at least one portion of said one or more light beams may delimit at least one portion of a perimeter of the interaction area.

Still according to the invention, the processing electronic means, on the basis of said at least one signal received by the detecting means, may be capable to discriminate the direction of passage of said at least one participant through at least one portion of a perimeter of the interaction area, so as to recognise an entry into or an exit from the interaction area by said at least one participant.

Furthermore according to the invention, said at least one portion of said one or more light beams may comprise at least one pair of parallel light beams arranged in correspondence with said at least one portion of the perimeter of the interaction area, the processing electronic means discriminating said direction of passage of said at least one participant through the chronological analysis of interruptions of the pair beams belonging to said at least one pair.

Always according to, the invention, said one or more light emitters may be arranged along at least one first sensorised post and said one or more corresponding photoelectric cells may be arranged along at least one second sensorised post.

Still according to the invention, said at least one first sensorised post and said at least one second sensorised post may be each provided, at different heights above the floor of the interaction area, with pairs of light emitters and pairs of photoelectric cells, in such location as to allow their alignment with the pairs of light emitters and the pairs of photoelectric cells of two respective identical sensorised posts.

Furthermore according to the invention, at least one pair of sensorised posts between which said one or more light beams are generated may be rigidly connected through connecting longitudinal members.

Always according to the invention, the processing electronic means, on the basis of said at least one signal received from the detecting means, may be capable to discriminate an age range of said at least one participant.

Still according to the invention, the detecting means may comprise radar and/or echographic and/or radiofrequency detecting means, preferably for reading transponder devices mounted on objects, and/or magnetic stripe reading means and/or bar code reading means and/or microchip card or smartcard reading means.

Furthermore according to the invention, the detecting means may comprise at least one thermal detector or infrared ray volume sensor.

Always according to the invention, said detecting means may comprise pressure detecting means, arranged in the floor of the interaction area, capable to detect tread of the floor.

Still according to the invention, the floor of the interaction area may comprise one or more tiles provided with said pressure detecting means.

Furthermore according to the invention, said pressure detecting means may be capable to detect a body weight, preferably due to said at least one participant, resting on the same.

Always according to the invention, said pressure detecting means may comprise weight sensors, preferably mercury sensors.

Still according to the invention, said detecting means may comprise presence detecting means, arranged in the floor of the interaction area, capable to detect presence of said at least one participant on the floor.

Furthermore according to the invention, the floor of the interaction area may comprise one or more tiles provided with said presence detecting means.

Always according to the invention, said presence detecting means may comprise variable inductance sensors.

Still according to the invention, the processing electronic means, on the basis of said at least one signal received from the detecting means, may be capable to discriminate a distribution of said at least one participant within the interaction area.

Furthermore according to the invention, said multimedia playing means may comprise at least one display and/or one or more audio speakers.

Always according to the invention, the system may further comprise selection means operatable by said at least one participant, said at least one video and/or audio content played on the multimedia playing means being conditional on at least one signal received by the processing electronic means from the selection means.

Still according to the invention, said selection means may include one or more keys and/or a microphone connected to said processing electronic means that is capable to carry out a speech recognition of selections spoken by said at least one participant.

Furthermore according to the invention, said selection means may include means for detecting presence and position of objects in proximity of said at least one display, connected to said processing electronic means, so that this is capable to recognise a selection by said at least one participant on the basis of at least one signal received from said detectors of presence and position of objects in proximity of said at least one display.

Always according to the invention, said means for detecting presence and position of objects in proximity of said at least one display may comprise further photoelectric means capable to generate one or more light beams in proximity of said at least one display and to detect interruption of said one or more light beams when they are intersected by an outline of said objects.

Still according to the invention, the system may further comprise means for pointing a graphic cursor moving over said at least one display, that preferably includes at least one mouse and/or at least one gamepad.

Furthermore according to the invention, said detecting means may further comprise at least one camera, preferably a digital video camera, that provides said processing electronic means with photogram sequences, preferably from 5 to 25 per second.

Always according to the invention, said at least one camera may be flexible, the orientation of which being controlled by said processing electronic means.

Still according to the invention, the system may further comprise a background panel located so as to be a background of said photograms of said at least one camera.

Furthermore according to the invention, the background panel may be of homogeneous colour.

Always according to the invention, said processing electronic means may be capable to acquire, before said at least one participant is present within the interaction area, at least one background of said photograms.

Still according to the invention, said processing electronic means may be capable to crop an image of said at least one participant.

Furthermore according to the invention, said processing electronic means may crop the image of said at least one participant through the chrominance filter method (or “chroma key” method) applied to the colour of the background panel.

Always according to the invention, said processing electronic means may crop the image of said at least one participant by recognising differences of said photograms with respect to the preliminarily acquired background.

Still according to the invention, said processing electronic means may be capable to detect at least one selection expressed by said at least one participant on the basis of said photogram sequences.

Furthermore according to the invention, said processing electronic means may detect said at least one selection through a chromatic analysis of said photograms.

Always according to the invention, said processing electronic means may detect said at least one selection by recognising at least one corresponding gesture of said at least one participant.

Still according to the invention, said at least one gesture may comprise raising at least one hand above head of said at least one participant, said processing electronic means detecting when said at least one hand surpasses a horizontal line tangent to a top outline of the head.

Furthermore according to the invention, said processing electronic means may comprise at least one tracking automatic apparatus, capable to identify an outline of q bosom and/or head of said at least one participant, so as to control said at least one camera in order to follow said at least one participant.

Always according to the invention, said processing electronic means may comprise at least one Programmable Logic Controller or PLC device connected to at least one personal computer or PC.

Still according to the invention, said processing electronic means may store a set of video and/or audio contents and a logic chart, preferably structured according to a logic tree, of at least one sequence of video and/or audio contents belonging to said set which is played on the multimedia playing means, said logic chart comprising one or more branches of said at least one sequence of video and/or audio contents conditional to said at least one signal received by the processing electronic means from the detecting means.

Furthermore according to the invention, said logic chart may comprise one or more branches of said at least one sequence of video and/or audio contents conditional to said at least one signal received by the processing electronic means from the selection means.

Always according to the invention, one or more video and/or audio contents of said at least one sequence may be randomly selected by said processing electronic means out of a sub-set of video and/or audio contents belonging to said set, said processing electronic means preferably keeping a historical, memory of said one or more video and/or audio contents randomly selected out of said sub-set which are played on the multimedia playing means.

The present invention will now be described, by way of illustration and not by way; of limitation, according to its preferred embodiment, by particularly: referring to the figures of the enclosed drawings, in which:

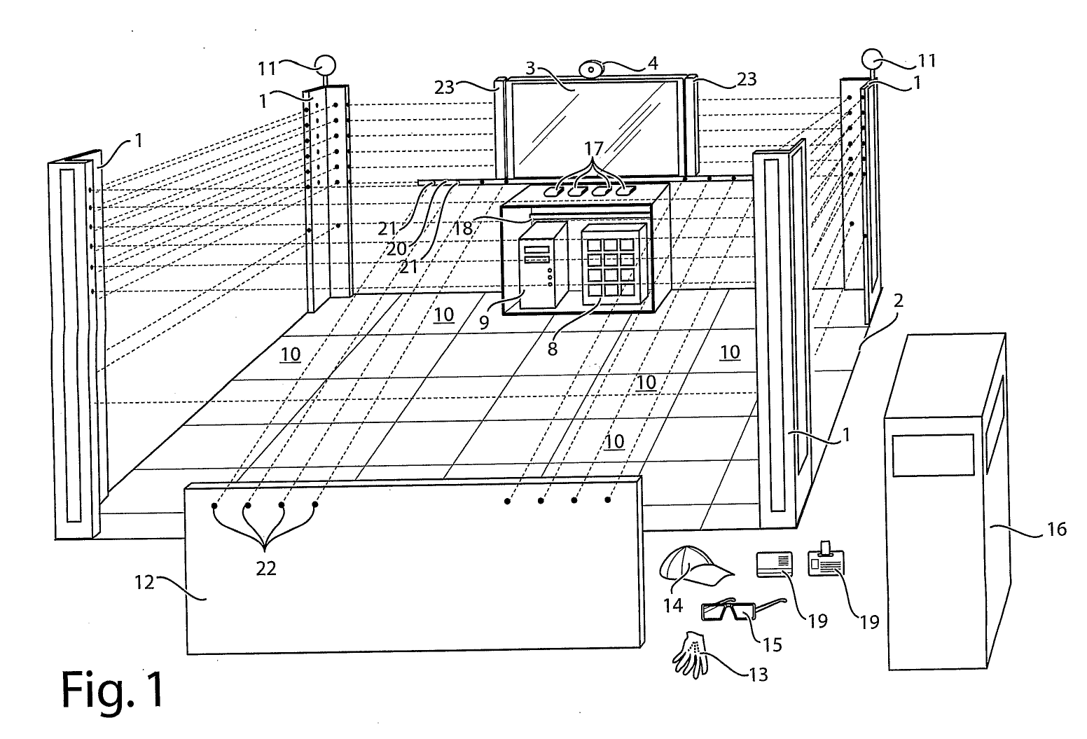

FIG. 1 shows a schematic perspective view of a preferred embodiment of the system according to the invention;

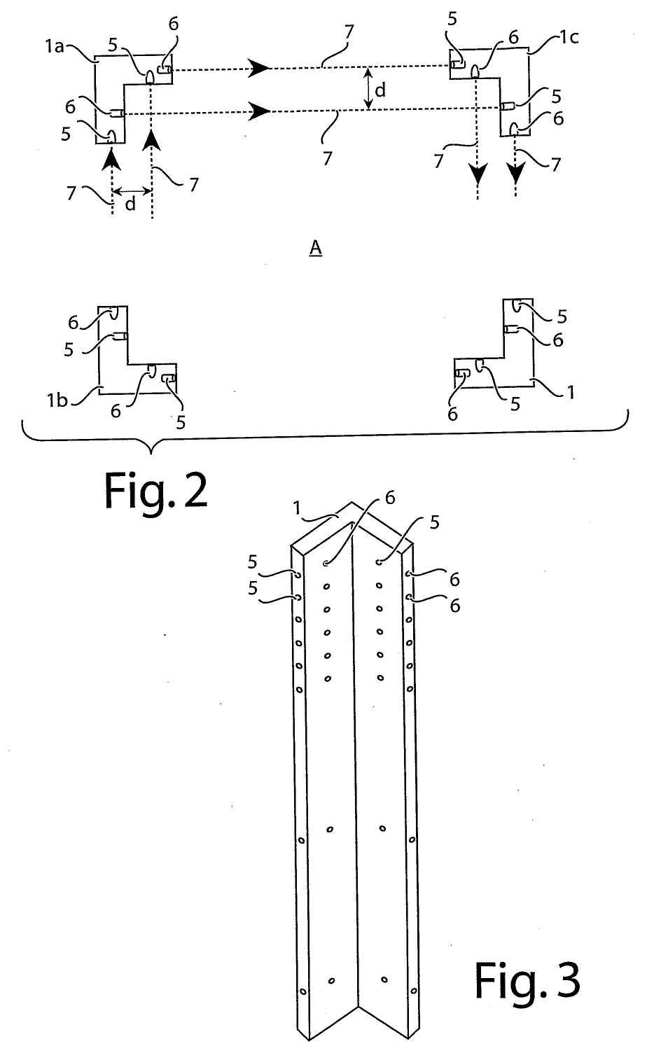

FIG. 2 shows a top plan view of a portion of the system of FIG. 1;

FIG. 3 shows a perspective view of an element of the system of FIG. 1;

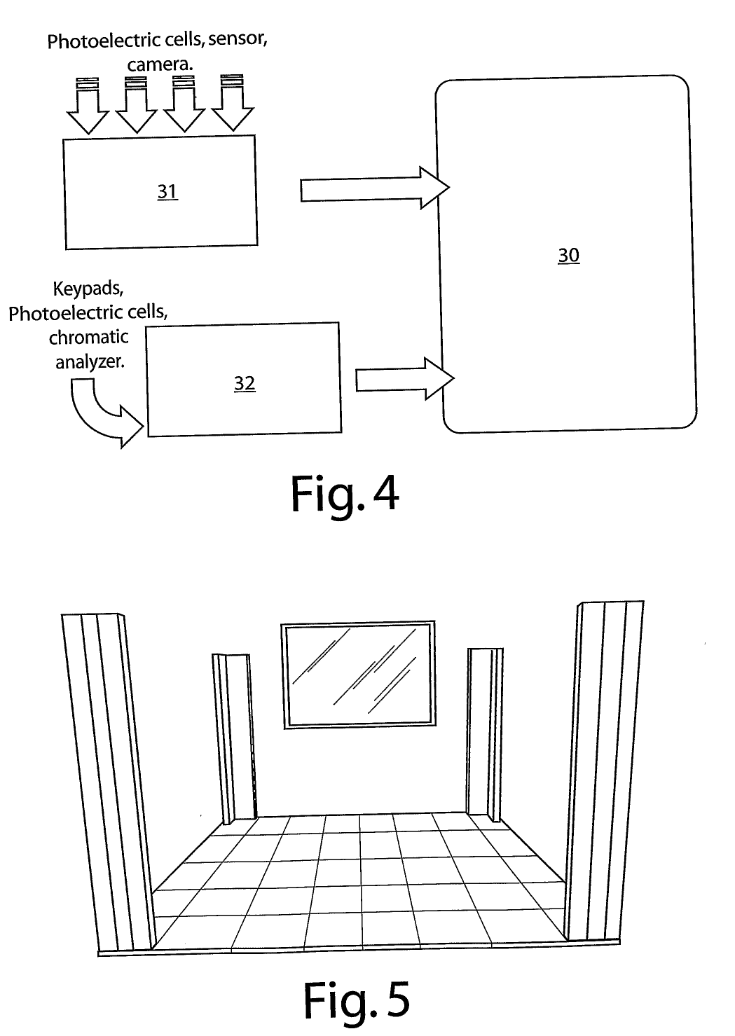

FIG. 4 shows a schematic block diagram of an element of the system of FIG. 1; and

FIG. 5 shows a second schematic perspective view of the system of FIG. 1.

In the following of the description, same references will be used for indicating alike elements in the Figures.

The system according to the invention is capable to offer communications, information or entertainment to the persons passing through the zone where it is installed, analysing and measuring reactions, decisions, and behaviours of the persons participating to the interaction with the same system. In particular, the system is capable to control a quick and immediate interaction, by customising messages, times and reactions, on the basis of different detected data (preferably related to the numerousness and types of the participating persons), and by reacting in an immediate and appropriate way to different events, such as entries, exits, or movements of persons, physical movements and posture changes, key pressing or other.

To this end, the system comprises a set of devices connected to a computer, preferably a personal computer or PC, which controls the whole system and plays, on at least one television display and on corresponding audio speakers, images and sounds preferably related to one or more characters (shown by video, such as actors or animated cartoons) interacting with the participants, in a designed and every time different way, through a suitable software system with which the PC is provided and which controls (video-motion picture and/or pre-recorded sound and/or pre-recorded or made at the moment graphic) multimedia playing. In this way, the system is capable to adjust messages, times and reactions on the basis of data detected by different detection devices with which it is provided, which are properly analysed by the system software.

As shown in FIG. 1, the preferred embodiment of the system according to the invention comprises a rectangular area of interaction delimited by sensorised posts 1 and provided with a sensorised floor or mat 2. The interaction area is preferably open along three sides, while a display 3 provided with audio speakers 23, being under a preferably flexible camera 4, is at the fourth side. Other embodiments of the system according to the invention may be installed in interaction areas of different shape.

As shown in greater detail in FIGS. 2 and 3, the sensorised posts 1 are preferably provided with photoelectric detectors for detecting entries and exits of participants. In the rectangular interaction area of FIGS. 1 and 2 there are four posts, located at the vertexes of the rectangle, so as to delimit the interaction area (indicated by reference A in FIG. 2). Each post 1 has a L-shaped cross section, and it is provided, at different heights above floor, with pair of photoelectric detectors or photoelectric cells 5 and with pair of light emitters 6. As shown in FIG. 2, posts 1 are aligned with each other so that each pair of photoelectric cells 5 of a first post 1-a is facing the pair of light emitters 6, located at the same height above floor of the pair of photoelectric cells 5 under consideration, of a second post 1-b, located at the vertex of the area A preceding the one where the first post 1-a is located, while the pair of light emitters 6 of the first post 1-a, located at the same height, is facing the pair of photoelectric cells 5, located at the same height, of a third post 1-c, located at the vertex of the area A following the one where the first post 1-a is located. Preferably, the bases of the sensorised posts 1 are rigidly connected through connecting longitudinal members, in order to keep the photoelectric cells 5 aligned with the corresponding facing emitters 6.

As shown in FIG. 2, distance d between parallel light beams 7 generated by a pair of emitters 6, located at a same height, and received by corresponding photoelectric cells 5, that preferably ranges from 4 to 12 cm, is such to allow the system to discriminate the direction of passage of a person through such beams 7, on the basis of the chronological analysis of interruptions of the pair beams 7 which are intersected by such person's outline. In this way, the system is capable to recognise either the entry into or the exit from the interaction area A by the participants. Moreover, the sensorised posts 1 may also provide an indication about the height of the participant who passed through the light beams and hence, indirectly, about his/her age range (child, boy, adult).

To this end, still with reference to FIG. 1, a device 8 implemented through programmable logic controllers or PLC receives signals coming from the sensorised posts 1 and interprets them, obtaining in real time a numerical value indicating the number of persons present within the area in every moment. This datum is put at disposal of the PC 9 through a connection, preferably a cable connection, more preferably through a RS-232 serial port. In particular, the PC 9 and the device 8 are preferably housed within a same cabinet.

Preferably, the sensorised posts 1 are provided with lighting devices controlled by the PC 9, such as coloured LED vertically located over the external surfaces of each wing of the “L” of each post 1, which are automatically turned on as soon as at least one participant is present within the interaction area A, and they are still automatically turned off after the last participant has left.

Other embodiments of the system according to the invention may comprise, either alternatively or in combination with the sensorised posts 1, different detecting means, such as for instance radar or echographic (acoustic) devices, or they may have a different arrangement of the photoelectric cells and of the corresponding emitters, for instance at the ceiling and on the floor, so that the light beams extends vertically. In this way, it is also possible to make interaction areas more complex, having a perimeter with curvilinear sides (besides straight ones as in the case of FIGS. 1-3).

Still with reference to FIG. 1, the preferred embodiment of the system comprises a sensorised floor or mat 2 made of a matrix of tiles 10 provided with pressure sensors. Preferably, the tiles 10 are square shaped, more preferably with, side ranging from 10 to 20 cm, and they cover the ground of the whole interaction area in front of the display 3. As said, each tile 10, that may be made of various materials (for instance plastic and/or linoleum and/or fabric and/or moquette materials), contains inside a pressure sensor capable to provide the device 8 with a signal indicative of whether the tile is trodden or not. The device 8 receives the signals coming from each tile 10 of the matrix of the floor 2, it digitises them, it analyses them, and it puts them at disposal of the PC 9, preferably through a further RS-232 serial connection.

Other embodiments of the system according to the invention may provide that each tile 10 comprises, either alternatively or in combination with the pressure sensor, a weight sensor (for instance mercury sensor) capable to output to the device 8 a corresponding analog signal indicative of the weight of the body resting on the tile 10. In this case, although the system is more expensive, detection made by the floor 2 is more precise; in fact, it is possible, for instance, to discriminate the case of a sole person placing his/her feet over two tiles 10 from the case of two persons placing both feet over a single tile 10.

Further embodiments of the system according to the invention may provide that the floor 2 comprises other devices capable to detect the presence, capable to detect tread of the floor 2 by one or more persons, preferably further determining the position on the floor. By way of example such devices may comprise variable inductance presence sensors, which for instance include a metallic net embedded within the floor, preferably located so as to detect the presence of a persona on each tile 10 (for instance a presence sensor per tile 10).

The use by the system software of the signals outputted by the matrix of tiles 10 is to make, some calculations for verifying the effective numerousness of persons within the interaction area, by verifying the correctness of processing based on the signals coming from the sensorised posts 1 (in this way the system would solve possible ambiguities and it would be more robust with respect to possible “deceptions” by participants who could activate a detection by the sensorised posts 1 in the case where no participant has effectively entered or left the interaction area, such as, for instance, in the case of a participant remaining with his/her body outside the interaction area and interrupting the light beams 7 generated by the posts 1 by means of hands, feet, or objects). Moreover, signals coming from the floor 2 may be used for detecting the distribution of participants within the interaction area, evaluating centreness or laterality of position of participants, allowing projection on the display 3 of different scenes depending on the position of participants (characterised, for instance, by appropriate direction of glance of movie characters, specific positions of graphical objects, suitable verbal references to position/movement of participants). In this regard, the system according to the invention could also comprise a plurality of displays (preferably located on different sides of the interaction area), all controlled by a same PC 9, on each one of which a different character discusses or debates with other characters projected on other displays and/or with the participants.

Alternatively, or in combination with the sensorised floor 2, other embodiments of the system could comprise photoelectric cell devices capable to detect presence and position of participants on the basis of the interruption of vertical light beams. For instance, the system may provide a plurality of pair of facing photoelectric cell-light emitter, wherein the photoelectric cells are flush-mounted on the floor 2 and the corresponding emitters are attached to the ceiling, or vice versa. Alternatively, the floor 2 could have a mirror, so as to reflect a light beam generated by the emitter of a device attached to the ceiling and also provided with a photosensor capable to detect the beam reflected by the floor 2.

The system of FIG. 1 still comprises a pair of infrared ray presence thermal detectors 11 (also called infrared ray volume sensors), preferably placed on the two sensorised posts 1 located sideways to the display 3 and connected to the device 8. Such thermal detectors 11 detect the presence of participants within the interaction area, allowing the device 8 and/or the PC 9 to make a verification crossed with processing of the signals coming from the sensorised posts 1 and the floor 2 on presence and number of participants, allowing to a greater extent the system to solve possible ambiguities and to determine possible “deceptions” by participants.

Other embodiments of the system may comprise a different number of thermal detectors 11, also arranged in a different manner (for instance, at the ceiling).

The camera 4 is preferably a digital video camera, directly connected to the PC 9, preferably through a USB port, to which it outputs a sequence of photograms (preferably 5 to 25 per second). Thanks to the presence of a background panel 12 of homogeneous colour, located in the interaction area on the side opposite to the camera 4, the PC 9 is capable to process the sequences outputted by the camera 9 in order to:
crop the image of the participant(s) possibly present within the interaction area, through the chrominance filter method applied to the colour of the background panel 12 (also known as “chroma key” method), and to be capable to show it on the display 3 in decontextualised situations, on graphical and photographic background at will;
make some calculations for verifying, on the basis of the analysis of chrominance differences from the background panel 12, the effective numerousness of participants within the interaction area;
detect possible parameters of vote/selection/assent made through showing by the participant(s) objects (such as for instance gloves 13, hats 14, or glasses 15) of particular chromatic evidence (pickable by participants from suitable containers 16, located at the entrance of the interaction area or under the display 3); in particular, the chromatic analysis may be made by the software of PC 9 through an algorithm capable to recognise patches of a particular colour within the shot of the camera 3, while modes of vote/selection/assent through the use of these objects may be advantageously directly shown by movie characters appearing on the display 3.

Other embodiments of the system according to the invention may provide that the software of PC 9 is capable to recognise certain gestures of participant(s), so as to associate specific messages by participant(s) when, for instance, he/she raises one or both hands above head, detecting, through the chrominance filter along with the colour of the background panel 12, when the arms surpasses the horizontal line tangent to the top outline of the head.

Still, further embodiments may provide, instead of a panel 12 of homogeneous colour, a non-monochromatic panel or even no panel at all. In this case, during interaction, the software of PC 9 must be capable to recognise the differences with respect to the starting background (for instance the background of a shop or museum wherein the interaction area of the system is), previously acquired in a preliminary step.

In particular, among the photo cameras which may be used as camera 3, there exist some provided with an automatic apparatus of tracking, capable to identify the outline of the bosom and/or head of a person and to follow it during its movements through a motorised training system.

Other embodiments of the system according to the invention may comprise more than one camera, each one of which may be sequentially enabled to shoot one person at a time of those entering and, preferably, to follow its movements.

The system of FIG. 1 still comprises devices for selecting and pointing a cursor moving over the display 3, such as a keyboard, a mouse, a trackball, or a gamepad, similar to the analogous devices normally used with a PC, even in terms of connection to the system PC 9 and of operation. The sole difference is preferably represented by the enlarged size, so as to make them easier to handle, or a simplified configuration, such as for instance in the case of keypads with few keys 17, coloured in different way or with large marks (for instance “YES”/“NO”, or “A”/“B”/“C”, or “1”/“2”/“3”, or up/down/right/left move arrows, or the like), in order to be able to obtain situations assimilable to the context, for instance, of a videogame or tv quiz.

Other embodiments of the system according to the invention may comprise pair of facing horizontal and/or vertical bars, arranged above and under and/or rightwards and leftwards the display 3, respectively provided with photoelectric cells and light emitters, capable to generate parallel light beams, so as to detect when a participant hand approaches the display 3 in certain positions, and thus recognising a corresponding selected choice/vote/answer, through hand gesture, from options shown on the display 3. In particular, in the system of FIG. 1, the two sensorised posts 1 arranged at the sides of the display 3 just carry out the detection of objects or persons approaching the display 3. Alternatively, the display 3 may be provided with a sensible surface of “touch screen” type.

Still, other embodiments of the system according to the invention may comprise a microphone connected to PC 9 for speech recognition of selections spoken by participants at the interaction, either alternatively or in combination with the previously described selection devices.

The system of FIG. 1 further comprises an antenna 18 for detecting transponders mounted on objects. By way of example, such objects may be articles on sale provided with transponders for anti-theft protection: in this case the system is capable to recognise the possible purchase of or intention to purchase articles by participant(s), consequently making reference to them in movie messages. Alternatively, such objects may be badges 19, allowing the system to interact making reference to the participant's identity and/or to his/her data stored in the badge (as, for instance, his/her interests or hobbies). Still, such objects may be gadgets (such as caps, glasses or the like) provided with transponders, which participants may wear, after having received them from personnel or picked them up from a suitable container located in proximity of the interaction area.

Other embodiments may also comprise readers for magnetic stripes, bar codes, or smartcards (microchip cards) with which badges are provided.

Finally, the system of FIG. 1 still comprises a bar 20, located on the wall of the display 3, provided with photoelectric cells 21 facing light emitters 22, located in the background panel 12, which generate horizontal parallel light beams inside the interaction area. The photoelectric cells 22 send detection signals to PC 9, allowing a detection of the front size of the outline of participants and of their position in direction parallel to the plane of the display 3.

With reference now to FIG. 4, it may be observed that the system software comprises three main modules, always simultaneously active.

A main module 30 is the logic engine controlling the system, and its interactions with participants. It comprises several components:
a logic flow manager, that, on the basis of the signals received from the several detecting devices, determines the flow of events and triggers the launch of video and audio resources;
a sequencer, that provides sending audio and video streaming commands to a media player, managing its timing and sequencing, besides events of sudden interruption (on change of the scenarios of occupation of the interaction area and of the behaviour of participants), in aesthetically significant instants;
the media player, preferably based on standard MCI functions of Windows XP; and
the randomizer, that provides choosing among different versions and variants of audio/video resources corresponding to a same situation, keeping historical track of the already used ones, so as not to cause repetitiveness and foreseeability effects in situations appearing on the display 3.

The second module of the software is an automaton 31, always active, for analysing input signals from the detecting devices. It is continuously connected to all the detecting devices, and it analyses the signals thereof. The automaton 31 is capable to combine redundant input signals related to the same information (for instance participant numerousness provided by sensorised posts 1, by sensorised floor 2, and by thermal detectors 11) with each other, solving possible conflicts through algorithms of logic, euristic, or neural type. The automaton 31 also carries out the chromatic analysis of the images detected by camera 4, by applying the chrominance filter for separating the images of participants from the background panel 12.

The third module of the software is an automaton 32 controlling peripherals of vote/choice/logic interaction (such as keypads, touch screen, mouse, trackball, gamepad, photoelectric cells for detecting approach to display, etc.). Also the automaton 32 is preferably always active, but the main module 30 takes account of its signals only at moments of logic branch of, the interactive flow of the multimedia sequences. However, in every case, the activity level detected in the remaining moments may be used as further indirect index of presence and/or physical activity of participants.

For each context into which the system may be installed, a set of software products capable to generate a corresponding multimedia sequence must be produced.

First of all, it is necessary a file or script encoding the logic flow of the multimedia sequence, i.e., containing the logic flow chart, preferably structured according to a logic tree, of situations and related branches depending on the interactions of participants. This script must be accompanied by a set of multimedia resources, such as movies and audio excerpts, synchronised with each other, stores in a suitable memory (for instance within PC 9), which are played for each situation.

In the following an example of logic flow of multimedia sequence is given.

When there are no participants within the interaction area, the system may play a movie character in a waiting situation, e.g. reading something (as schematically shown in FIG. 5). Alternatively, the randomizer could select a different movie, wherein the character appears thoughtful, or watches elsewhere, or sleeps holding head between hands.

When the system detects that a participant has entered the interaction area, a movie is played on display 3 wherein the character notices the entry of the participant (the randomizer randomly selects one out of several variants of scenes of attention and glance towards who is entering).

At this point, a movie is played on display 3 wherein the character is taken close-up for asking a question (the randomizer randomly selects one out of several variants of question scenes, preferably also depending on number and type of detected participants).

In case of occurrence of a new event, such as the exit of participant(s) (possibly even recognised, for instance the first participant who entered) or the entry of further participants, a movie is played wherein the character makes a visual and/or gesture comment on the event, for instance by greeting (the randomizer randomly selects one out of several variants of comment scenes).

Afterwards, the system may play on display 3 a movie wherein the character deals with the specific subject matter of information/entertainment, by asking, for instance, a specific question to a particular participant or to all the participants, on the subject matter (the randomizer randomly selects one out of several variants of question scenes). On the basis of the received reply or the absence of reply, a movie is played wherein the character makes a specific verbal and/or gesture comment on the reply or absence of reply (the randomizer randomly selects one out of several variants of comment scenes).

With such flow, it is clear that the system may continue playing on display 3 a movie wherein the character makes verbal and/or gesture comments pertinent to the occurrence of further new events, randomly selected by the randomizer, such as entry of other participants, exit of one or more, but not all, participants, or exit of all participants.

At the end of the interaction, for instance at the end of delivery of a series of information or of asking a series of questions, the system may play on display 3 a movie wherein the character makes a conclusive comment (the randomizer randomly selects one out of several variants of conclusive comment scenes).

In absence of new events, the system may play on display 3 a scene of goodbye/farewell and return to a thoughtful position of the character (the randomizer randomly selects one out of several variants of such scenes).

In particular, in the case afterwards not all the participants leave, the system may play on display 3 a scene wherein the character notices stay of visitors, but he decides not to take them into consideration (the randomizer randomly selects one out of several variants thereof).

In other words, the logic flow of the interactive multimedia sequence provides that after an introductive movie, playing continues with movies depending on detections made by the system related to events occurring within the interaction area (for instance entries and exits of participants) and on choices/selections made by participants (for instance in reply to a question by a movie character). In particular, PC 9, on the basis of signals coming from the several detection and interaction devices, controls the movie sequence conditional on detections and choices of participants by randomly selecting movies out of possible variants corresponding to the various situations.

The advantages offered by the system according to the invention are evident, which system may be placed in places of commercial type (shops, supermarkets, exhibition stands, etc.) or public type (halls of stations, ports or airports, agencies or institutions; touristic sites, museums, etc.), ensuring delivery of communications, information or entertainment opportunities in an extremely interactive way.

The present invention has been described, by way of illustration and not by way of limitation, according its preferred embodiment, but it should be understood that those skilled in the art can make variations and/or changes, without so departing from the related scope of protection, as defined by the enclosed claims.

1. An interactive multimedia system comprising a processing electronic means that controls multimedia playing means for playing at least one video and/or audio content, the system further comprising a detecting means, capable to detect presence of at least one participant within an interaction area having a floor treadable by said at least one participant, connected to the processing electronic means, said at least one video and/or audio content played on the multimedia playing means being conditional on at least one signal received by the processing electronic means from the detecting means wherein said processing electronic means stores a set of video and/or audio contents and a logic chart, structured according to a logic tree, of at least one sequence of video and/or audio contents belonging to said set which is played on the multimedia playing means, said logic chart comprising one or more branches of said at least one sequence of video and/or audio contents conditional to said at least one signal received by the processing electronic means from the detecting means.

2-46. (canceled)

47. A system according to claim 1, wherein the detecting means comprises a photoelectric means capable to generate one or more light beams and to detect interruption of said one or more light beams when they are intersected by an outline of said at least one participant.

48. A system according to claim 47, wherein the photoelectric means comprises one or more photoelectric sensors or photoelectric cells which receive said one or more light beams generated by one or more corresponding light emitters.

49. A system according to claim 48, wherein said one or more photoelectric sensors or photoelectric cells face said one or more corresponding light emitters.

50. A system according to claim 47, wherein at least one portion of said one or more light beams are generated according to at least one direction parallel to the floor of the interaction area.

51. A system according to claim 47, wherein at least one portion of said one or more light beams are generated according to at least one direction orthogonal to the floor of the interaction area.

52. A system according to claim 51, wherein the photoelectric means comprises one or more photoelectric sensors or photoelectric cells which receive said one or more light beams generated by one or more corresponding light emitters, wherein the floor of the interaction area is capable to reflect said one or more light beams and in that said one or more photoelectric sensors or photoelectric cells and said one or more corresponding light emitters are arranged in the same floor or in a ceiling of the interaction area.

53. A system according to claim 47, wherein at least one portion of said one or more light beams delimits at least one portion of a perimeter of the interaction area.

54. A system according to claim 1, wherein the processing electronic means, on the basis of said at least one signal received by the detecting means, is capable to discriminate the direction of passage of said at least one participant through at least one portion of a perimeter of the interaction area, so as to recognise an entry into or an exit from the interaction area by said at least one participant.

55. A system according to claim 54, wherein at least one portion of said one or more light beams delimits at least one portion of a perimeter of the interaction area, wherein said at least one portion of said one or more light beams comprises at least one pair of parallel light beams arranged in correspondence with said at least one portion of the perimeter of the interaction area, the processing electronic means discriminating said direction of passage of said at least one participant through the chronological analysis of interruptions of the pair beams belonging to said at least one pair.

56. A system according to claim 53, wherein said one or more photoelectric sensors or photoelectric cells face said one or more corresponding light emitters, and wherein at least one portion of said one or more light beams are generated according to at least one direction parallel to the floor of the interaction area, wherein said one or more light emitters are arranged along at least one first sensorised post and said one or more corresponding photoelectric cells are arranged along at least one second sensorised post.

57. A system according to claim 56, wherein at least one portion of said one or more light beams delimits at least one portion of a perimeter of the interaction area, wherein said at least one portion of said one or more light beams comprises at least one pair of parallel light beams arranged in correspondence with said at least one portion of the perimeter of the interaction area, the processing electronic means discriminating said direction of passage of said at least one participant through the chronological analysis of interruptions of the pair beams belonging to said at least one pair, wherein said at least one first sensorised post and said at least one second sensorised post are each provided, at different heights above the floor of the interaction area, with pairs of light emitters and pairs of photoelectric cells, in such location as to allow their alignment with the pairs of light emitters and the pairs of photoelectric cells of two respective identical sensorised posts.

58. A system according to claim 56, wherein at least one pair of sensorised posts between which said one or more light beams are generated are rigidly connected through connecting longitudinal members.

59. A system according to claim 1, wherein the processing electronic means, on the basis of said at least one signal received from the detecting means, is capable to discriminate an age range of said at least one participant.

60. A system according to claim 1, wherein the detecting means comprises radar and/or echographic and/or radiofrequency detecting means, preferably for reading transponder devices mounted on objects, and/or magnetic stripe reading means and/or bar code reading means and/or microchip card or smartcard reading means.

61. A system according to claim 1, wherein the detecting means comprises at least one thermal detector or infrared ray volume sensor.

62. A system according to claim 1, wherein said detecting means comprises pressure detecting means, arranged in the floor of the interaction area, capable to detect tread of the floor.

63. A system according to claim 62, wherein the floor of the interaction area comprises one or more tiles provided with said pressure detecting means.

64. A system according to claim 62, wherein said pressure detecting means is capable to detect a body weight, preferably due to said at least one participant, resting on the same.

65. A system according to claim 64, wherein said pressure detecting means comprises weight sensors, preferably mercury sensors.

66. A system according to claim 1, wherein said detecting means comprises presence detecting means, arranged in the floor of the interaction area, capable to detect presence of said at least one participant on the floor.

67. A system according to claim 66, wherein the floor of the interaction area comprises one or more tiles provided with said presence detecting means.

68. A system according to claim 66, wherein said presence detecting means comprises variable inductance sensors.

69. A system according to claim 66, wherein the processing electronic means, on the basis of said at least one signal received from the detecting means, is capable to discriminate a distribution of said at least one participant within the interaction area.

70. A system according to claim 1, wherein said multimedia playing means comprises at least one display and/or one or more audio speakers.

71. A system according to claim 1, wherein it further comprises selection means operatable by said at least one participant, said at least one video and/or audio content played on the multimedia playing means being conditional on at least one signal received by the processing electronic means from the selection means.

72. A system according to claim 71, wherein said selection means includes one or more keys and/or a microphone connected to said processing electronic means that is capable to carry out a speech recognition of selections spoken by said at least one participant.

73. A system according to claim 71, wherein said multimedia playing means comprises at least one display and/or one or more audio speakers, wherein said selection means includes means for detecting presence and position of objects in proximity of said at least one display, connected to said processing electronic means, so that this is capable to recognise a selection by said at least one participant on the basis of at least one signal received from said detectors of presence and position of objects in proximity of said at least one display.

74. A system according to claim 73, wherein said means for detecting presence and position of objects in proximity of said at least one display comprises further photoelectric means capable to generate one or more light beams in proximity of said at least one display and to detect interruption of said one or more light beams when they are intersected by an outline of said objects.

75. A system according to claim 71, wherein said multimedia playing means comprises at least one display and/or one or more audio speakers, wherein the system further comprises means for pointing a graphic cursor moving over said at least one display, that preferably includes at least one mouse and/or at least one gamepad.

76. A system according to claim 1, wherein said detecting means further comprises at least one camera, preferably a digital video camera, that provides said processing electronic means with photogram sequences, preferably from 5 to 25 per second.

77. A system according to claim 76, wherein said at least one camera is flexible, the orientation of which being controlled by said processing electronic means.

78. A system according to claim 76, wherein it further comprises a background panel located so as to be a background of said photograms of said at least one camera.

79. A system according to claim 78, wherein the background panel is of homogeneous colour.

80. A system according to claim 76, wherein said processing electronic means is capable to acquire, before said at least one participant is present within the interaction area, at least one background of said photograms.

81. A system according to claim 76, wherein said processing electronic means is capable to crop an image of said at least one participant.

82. A system according to claim 81, wherein the background panel is of homogeneous colour, wherein said processing electronic means crops the image of said at least one participant through the chrominance filter method (or “chroma key” method) applied to the colour of the background panel.

83. A system according to claim 81, wherein said processing electronic means is capable to acquire, before said at least one participant is present within the interaction area, at least one background of said photograms, wherein said processing electronic means crops the image of said at least one participant by recognising differences of said photograms with respect to the preliminarily acquired background.

84. A system according to claim 76, wherein said processing electronic means is capable to detect at least one selection expressed by said at least one participant on the basis of said photogram sequences.

85. A system according to claim 84, wherein said processing electronic means detects said at least one selection through a chromatic analysis of said photograms.

86. A system according to claim 84, wherein said processing electronic means detects said at least one selection by recognising at least one corresponding gesture of said at least one participant.

87. A system according to claim 86, wherein said at least one gesture comprises raising at least one hand above head of said at least one participant, said processing electronic means detecting when said at least one hand surpasses a horizontal line tangent to a top outline of the head.

88. A system according to claim 77, wherein said processing electronic means comprises at least one tracking automatic apparatus, capable to identify an outline of a bosom and/or head of said at least one participant, so as to control said at least one camera in order to follow said at least one participant.

89. A system according to claim 1, wherein said processing electronic means comprises at least one Programmable Logic Controller or PLC device connected to at least one personal computer or PC.

90. A system according to claim 71, wherein said logic chart comprises one or more branches of said at least one sequence of video and/or audio contents conditional to said at least one signal received by the processing electronic means from the selection means.

91. A system according to claim 1, wherein one or more video and/or audio contents of said at least one sequence are randomly selected by said processing electronic means out of a sub-set of video and/or audio contents belonging to said set, said processing electronic means preferably keeping a historical memory of said one or more video and/or audio contents randomly selected out of said sub-set which are played on the multimedia playing means.
